(19) United States
(12) Patent Application Publication
(10) Pub. No.: US 2024/0348479 A1
(43) Pub. Date: Oct. 17, 2024

(54) CHANNEL STATE FEEDBACK FOR REDUCED RESOURCE CONSUMPTION REFERENCE SIGNALS

(71) Applicant: QUALCOMM Incorporated, San Diego, CA (US)

(72) Inventors: Rui HU, Beijing (CN); Chenxi HAO, Beijing (CN); Wei XI, Beijing (CN); Yu ZHANG, San Diego, CA (US); Taesang YOO, San Diego, CA (US); Yuwei REN, Beijing (CN); Hao XU, Beijing (CN)

(21) Appl. No.: 18/683,465

(22) PCT Filed: Oct. 29, 2021
(86) PCT No.: PCT/CN2021/127254

§ 371 Date: Feb. 13, 2024

(51) Int. Cl. H04L 25/02; H04B 7/06; H04L 5/00; H04L 27/26

(52) U.S. Cl. CPC H04L 25/0254; H04B 7/0626; H04L 5/0053; H04L 25/0224; H04L 27/2613

(57) ABSTRACT

A method for wireless communication by a user equipment (UE), includes receiving, from a base station, a reference signal (RS) on a set of resource elements (REs), the RS having been multiplexed onto the set of REs based on a non-orthogonal cover code, and a number of REs in the set of REs being less than a number of ports associated with the RS. The method further includes estimating, at the UE via a channel estimation neural network, a channel based on receiving the RS. The method still further includes transmitting, to the base station, a feedback report associated with the estimated channel based on receiving the RS.

### FIELD OF THE DISCLOSURE

The present disclosure relates generally to wireless communications, and more specifically to channel state feedback (CSF) for reference signals that consume a reduced amount of resources.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example also known as discrete Fourier transform spread OFDM (DFT-s-OFDM)) on the uplink (UL), as well as supporting beamforming, multiple-input multiple-output (MIMO) antenna technology, and carrier aggregation.

Artificial neural networks may comprise interconnected groups of artificial neurons (for example neuron models). The artificial neural network may be a computational device or represented as a method to be performed by a computational device. Convolutional neural networks, such as deep convolutional neural networks, are a type of feed-forward artificial neural network. Convolutional neural networks may include layers of neurons that may be configured in a tiled receptive field. It would be desirable to apply neural network processing to wireless communications to achieve greater efficiencies.

In some conventional wireless communication systems, a base station may transmit a reference signal (RS), such as a channel state information (CSI) RS (CSI-RS), to a user equipment (UE) and receive a typical channel state feedback (CSF) report, such as a CSI report, from the UE, based on measurements performed on the reference signal. The typical CSF report provides information for a channel between the base station and the UE. In such conventional wireless communication systems, the typical CSF report may be an implicit report, such as a Type I report or Type II report, or an explicit report, such as a report indicating channel coefficients. In some wireless communication systems, an amount of resources used for transmitting the RS may be reduced by using a non-orthogonal cover code to multiplex a group of ports onto a group of resource elements, where a number of resource elements in the group of resource elements is less than a number of ports in the group of ports. In such wireless communication systems, a CSF reporting scheme specified for the RS transmitted on a reduced number of resources may be different from the typical CSF reporting scheme.

### SUMMARY

In one aspect of the present disclosure, a method for wireless communication by a user equipment (UE) includes receiving, from a base station, a reference signal (RS) on a set of resource elements (REs), the RS having been multiplexed onto the set of REs based on a non-orthogonal cover code, a number of REs in the set of REs being less than a number of ports associated with the RS. The method further includes estimating, at the UE via a channel estimation neural network, a channel based on receiving the RS. The method still further includes transmitting, to the base station, a feedback report associated with the estimated channel based on receiving the RS.

Another aspect of the present disclosure is directed to an apparatus including means for receiving, from a base station, a RS on a set of REs, the RS having been multiplexed onto the set of REs based on a non-orthogonal cover code, a number of REs in the set of REs being less than a number of ports associated with the RS. The apparatus further includes means for estimating, at the UE via a channel estimation neural network, a channel based on receiving the RS. The apparatus still further includes means for transmitting, to the base station, a feedback report associated with the estimated channel based on receiving the RS.

In another aspect of the present disclosure, a non-transitory computer-readable medium with non-transitory program code recorded thereon is disclosed. The program code is executed by a processor and includes program code to receive, from a base station, a RS on a set of REs, the RS having been multiplexed onto the set of REs based on a non-orthogonal cover code, a number of REs in the set of REs being less than a number of ports associated with the RS. The program code further includes program code to estimate, at the UE via a channel estimation neural network, a channel based on receiving the RS. The program code still further includes program code to transmit, to the base station, a feedback report associated with the estimated channel based on receiving the RS.

Another aspect of the present disclosure is directed to an apparatus for wireless communication at a UE. The apparatus having a processor, a memory coupled with the processor, and instructions stored in the memory and operable, when executed by the processor, to cause the apparatus to receive, from a base station, a RS on a set of REs, the RS having been multiplexed onto the set of REs based on a non-orthogonal cover code, a number of REs in the set of REs being less than a number of ports associated with the RS. Execution of the instructions also cause the apparatus to estimate, via a channel estimation neural network, a channel based on receiving the RS. Execution of the instructions further cause the apparatus to transmit, to the base station, a feedback report associated with the estimated channel based on receiving the RS.

In one aspect of the present disclosure, a method for wireless communication by a base station includes multiplexing an RS on onto a set of RS based on a non-orthogonal cover code, a number of REs in the set of REs may be less than a number of antenna ports associated with the RS. The method further includes transmitting, to a UE, the RS on the set of REs. The method still further includes receiving, from the UE, a feedback report associated with the RS. The method also includes recovering, at the base station, an estimate of a channel associated with the RS based on receiving the feedback report.

Another aspect of the present disclosure is directed to an apparatus including means for multiplexing an RS on onto a set of RS based on a non-orthogonal cover code, a number of REs in the set of REs may be less than a number of antenna ports associated with the RS. The apparatus further includes means for transmitting, to a UE, the RS on the set of REs. The apparatus still further includes means for receiving, from the UE, a feedback report associated with the RS. The apparatus also includes means for recovering, at the base station, an estimate of a channel associated with the RS based on receiving the feedback report.

In another aspect of the present disclosure, a non-transitory computer-readable medium with non-transitory program code recorded thereon is disclosed. The program code is executed by a processor and includes program code to multiplex an RS on onto a set of RS based on a non-orthogonal cover code, a number of REs in the set of REs may be less than a number of antenna ports associated with the RS. The program code further includes program code to transmit, to a UE, the RS on the set of REs. The program code still further includes program code to receive, from the UE, a feedback report associated with the RS. The program code also includes program code to recover, at the base station, an estimate of a channel associated with the RS based on receiving the feedback report.

Another aspect of the present disclosure is directed to an apparatus for wireless communication at a UE. The apparatus having a processor, a memory coupled with the processor, and instructions stored in the memory and operable, when executed by the processor, to cause the apparatus to multiplex an RS on onto a set of RS based on a non-orthogonal cover code, a number of REs in the set of REs being less than a number of antenna ports associated with the RS. Execution of the instructions also cause the apparatus to transmit, to a UE, the RS on the set of REs. Execution of the instructions further cause the apparatus to receive, from the UE, a feedback report associated with the RS. Execution of the instructions still further cause the apparatus to recover, at the base station, an estimate of a channel associated with the RS based on receiving the feedback report.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 illustrates an example implementation of designing a neural network using a system-on-a-chip (SOC), including a general-purpose processor, in accordance with certain aspects of the present disclosure.

FIGS. 4A, 4B, and 4C are diagrams illustrating a neural network, in accordance with aspects of the present disclosure.

FIG. 4D is a diagram illustrating an exemplary deep convolutional network (DCN), in accordance with aspects of the present disclosure.

FIG. 5 is a block diagram illustrating an exemplary deep convolutional network (DCN), in accordance with aspects of the present disclosure.

FIG. 6 is a block diagram illustrating an example of an artificial neural network, in accordance with various aspects of the present disclosure.

FIG. 7 is a timing diagram illustrating an example of reporting a quantized reference signal, in accordance with various aspects of the present disclosure.

FIG. 8 is a timing diagram illustrating an example of reporting a channel, in accordance with various aspects of the present disclosure.

FIG. 9 is a block diagram illustrating an example wireless communication device that supports neural network-based channel state feedback (CSF) reporting, in accordance with various aspects of the present disclosure.

FIG. 10 is a flow diagram illustrating an example process performed, for example, by a UE, in accordance with various aspects of the present disclosure.

FIG. 11 is a block diagram illustrating an example wireless communication device that supports neural network-based CSF reporting, in accordance with various aspects of the present disclosure.

FIG. 12 is a flow diagram illustrating an example process performed, for example, by a base station, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

As discussed above, in some conventional wireless communication systems, a base station may transmit a reference signal (RS), such as a channel state information (CSI) RS (CSI-RS), to a user equipment (UE) and receive a typical channel state feedback (CSF) report, such as a CSI report, from the UE. The typical CSF report provides information for a channel between the base station and the UE based on measurements performed on the RS by the UE. In some such conventional wireless communication systems, the typical CSF report may be an implicit report, such as a Type I report, a Type II report, or an enhanced Type II report. In other such conventional wireless communication systems, the typical CSF report may be an explicit report, such as a report indicating channel coefficients.

In some wireless communication systems, an RS may be multiplexed based on a non-orthogonal cover code to reduce an amount of resources used for transmitting the RS. In some examples, a group of ports Nₜ, specified for transmitting the RS, may be multiplexed onto a group of resource elements L, where a number of resource elements in the group of resource elements is less than a number of ports in the group of ports (L<Nₜ). The RS is multiplexed based on the non-orthogonal cover code, which may be associated with compressive sensing (CS)-based CSF reporting or neural network (NN)-based CSF reporting. In such wireless communication systems, a new CSF reporting scheme may be specified for the CS-based CSF reporting and the NN-based CSF reporting.

Various aspects disclosed relate generally to NN-based CSF reporting. Some aspects more specifically relate to a CSF reporting scheme for reference signals, such as CSI-RSs, transmitted on a reduced number of resources. In some examples, a UE receives a RS on a set of resource elements from a base station, the RS having been multiplexed by the base station based on a non-orthogonal cover code. The UE performs measurements on the received RS and an artificial neural network at the UE then estimates a channel between the base station and the UE based on the measurements of the RS. In some examples, the UE quantizes parameters associated with the measurements of the RS. In such examples, the CSF report indicates the quantized parameters. Additionally, an artificial neural network at the base station may process the quantized parameters to obtain its own estimate of the channel between the base station and the UE. In some other examples, the UE may estimate the channel based on a codebook associated with the artificial neural network. After estimating the channel, the UE may transmit, to the base station, a CSF report indicating parameters associated with the estimated channel based on a codebook associated with the artificial neural network. A payload size of the parameters is less than a payload size of a typical CSF report. In such examples, the base station may recover the channel based on the parameters indicated by the CSF report.

Particular aspects of the subject matter described in this disclosure can be implemented to realize one or more of the following potential advantages. In some examples, the described techniques provide an NN-based CSF reporting scheme. In such examples, the NN-based CSF-reporting scheme may reduce an amount of processing at a base station because an artificial neural network at the base station can recover an estimate of a channel between the base station and a UE based on one or more quantized values, reported by the UE, associated with measurements of an RS transmitted by the base station. Additionally, in some examples, the NN-based CSF-reporting scheme may reduce network overhead by reducing a payload size of a CSF report. In such examples, the CSF report indicates parameters associated with the estimated channel based on the codebook associated with the artificial neural network. The network overhead may be reduced because the payload size of the parameters is less than a payload size of a typical CSF report.

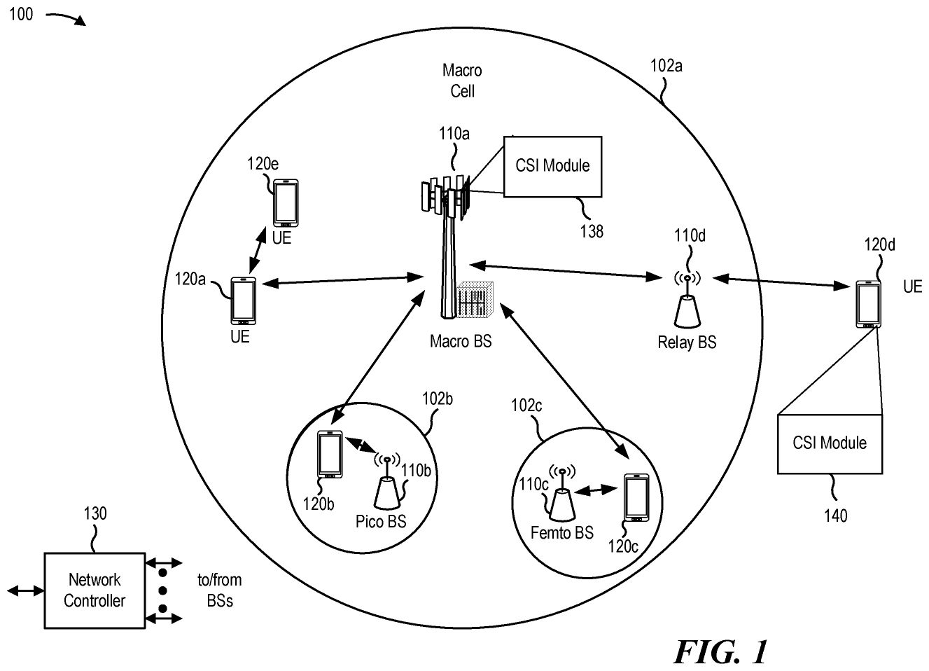

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B, an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example several kilometers in radius) and may allow unrestricted access by UEs with service subscription. A pico cell may cover a relatively small geographic area and may allow unrestricted access by UEs with service subscription. A femto cell may cover a relatively small geographic area (for example a home) and may allow restricted access by UEs having association with the femto cell (for example UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example three) cells. The terms “eNB,” “base station,” “NR BS,” “gNB,” “AP,” “node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example a BS or a UE) and send a transmission of the data to a downstream station (for example a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, for example macro BSs, pico BSs, femto BSs, relay BSs, and/or the like. These different types of BSs may have different transmit power levels, different coverage areas, and different impact on interference in the wireless network 100. For example, macro BSs may have a high transmit power level (for example 5 to 40 Watts) whereas pico BSs, femto BSs, and relay BSs may have lower transmit power levels (for example 0.1 to 2 Watts).

A network controller 130 may couple to a set of BSs and may provide coordination and control for these BSs. The network controller 130 may communicate with the BSs via a backhaul. The BSs may also communicate with one another, for example directly or indirectly via a wireless or wireline backhaul.

UEs 120 (for example 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example smart ring, smart bracelet)), an entertainment device (for example a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example remote device), or some other entity. A wireless node may provide, for example, connectivity for or to a network (for example a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example shown as UE 120a and UE 120e) may communicate directly using one or more sidelink channels (for example without using a base station 110 as an intermediary to communicate with one another). For example, the UEs 120 may communicate using peer-to-peer (P2P) communications, device-to-device (D2D) communications, a vehicle-to-everything (V2X) protocol (for example which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example a system information block (SIB).

The UEs 120 may include a CSI module 140. For brevity, only one UE 120d is shown as including the CSI module 140. The CSI module 140 may receive, from a base station, a RS on a set of REs, the RS having been multiplexed onto the set of REs based on a non-orthogonal cover code, a number of REs in the set of REs being less than a number of ports associated with the RS; estimate, via a channel estimation neural network, a channel based on receiving the RS; and transmit, to the base station, a feedback report associated with the estimated channel based on receiving the RS.

The base stations 110 may include a CSI module 138. For brevity, only one base station 110a is shown as including the CSI module 138. The CSI module 138 may multiplex an RS on onto a set of RS based on a non-orthogonal cover code; transmit, to a UE, the RS on the set of REs; receive, from the UE, a feedback report associated with the RS; and recover, at the base station, an estimate of a channel associated with the RS based on receiving the feedback report.

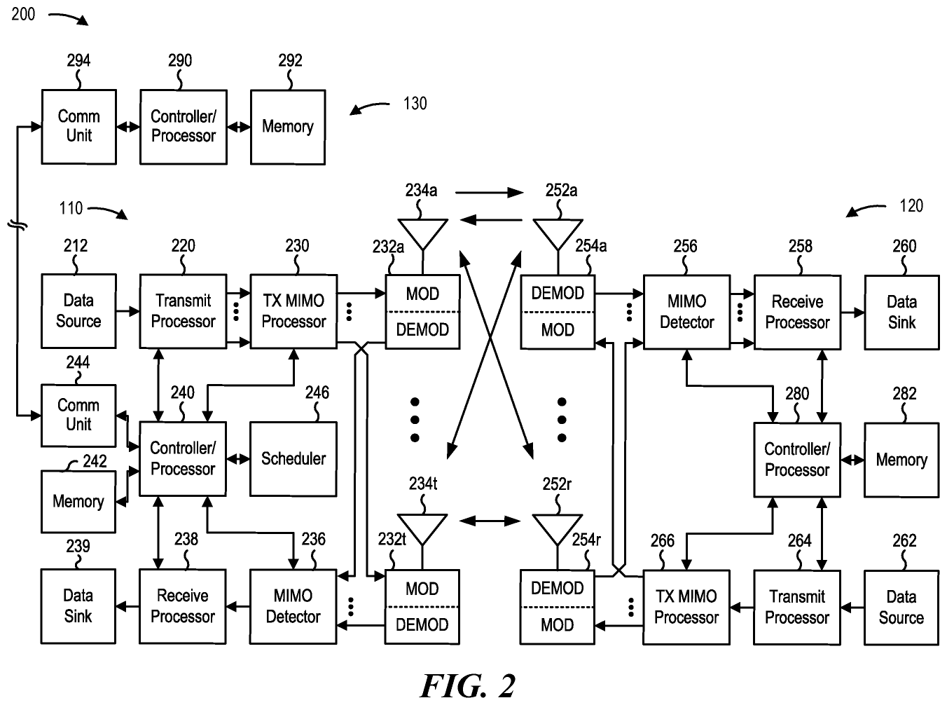

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example for semi-static resource partitioning information (SRPI) and/or the like) and control information (for example CQI requests, grants, upper layer signaling, and/or the like) and provide overhead symbols and control symbols. The transmit processor 220 may also generate reference symbols for reference signals (for example the cell-specific reference signal (CRS)) and synchronization signals (for example the primary synchronization signal (PSS) and secondary synchronization signal (SSS)). A transmit (TX) multiple-input multiple-output (MIMO) processor 230 may perform spatial processing (for example precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example for OFDM and/or the like) to obtain an output sample stream. Each modulator 232 may further process (for example convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example filter, amplify, downconvert, and digitize) a received signal to obtain input samples. Each demodulator 254 may further process the input samples (for example for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the network controller 130 via the communications unit 244. The network controller 130 may include a communications unit 294, a controller/processor 290, and a memory 292.

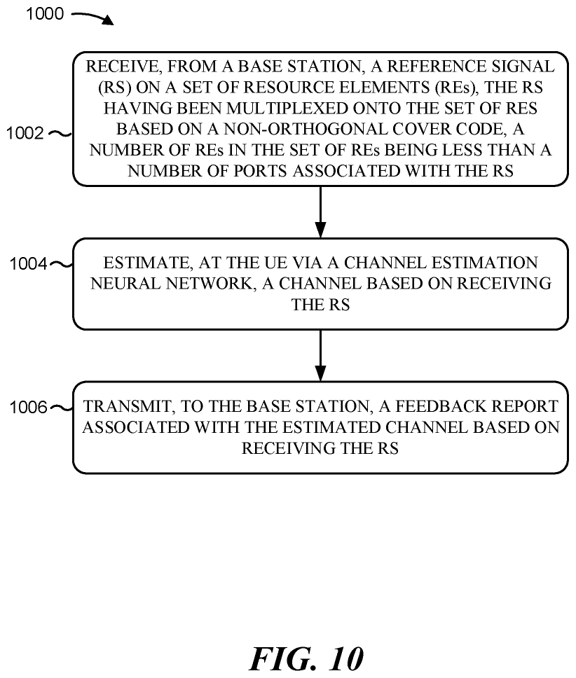

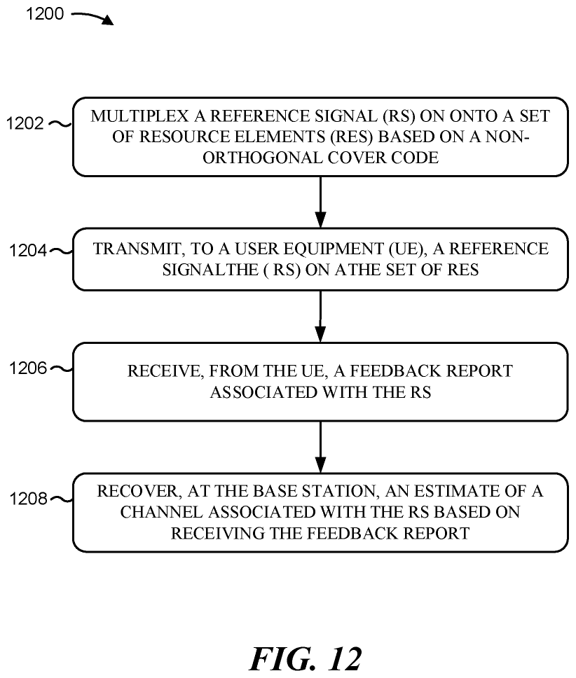

The controller/processor 240 of the base station 110, the controller/processor 280 of the UE 120, and/or any other component(s) of FIG. 2 may perform one or more techniques associated with machine learning for estimating a channel based on a reference signal, as described in more detail elsewhere. For example, the controller/processor 240 of the base station 110, the controller/processor 280 of the UE 120, and/or any other component(s) of FIG. 2 may perform or direct operations of, for example, the processes 1000 and 1200 of FIGS. 10 and 12 and/or other processes as described. Memories 242 and 282 may store data and program codes for the base station 110 and UE 120, respectively. A scheduler 246 may schedule UEs for data transmission on the downlink and/or uplink.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

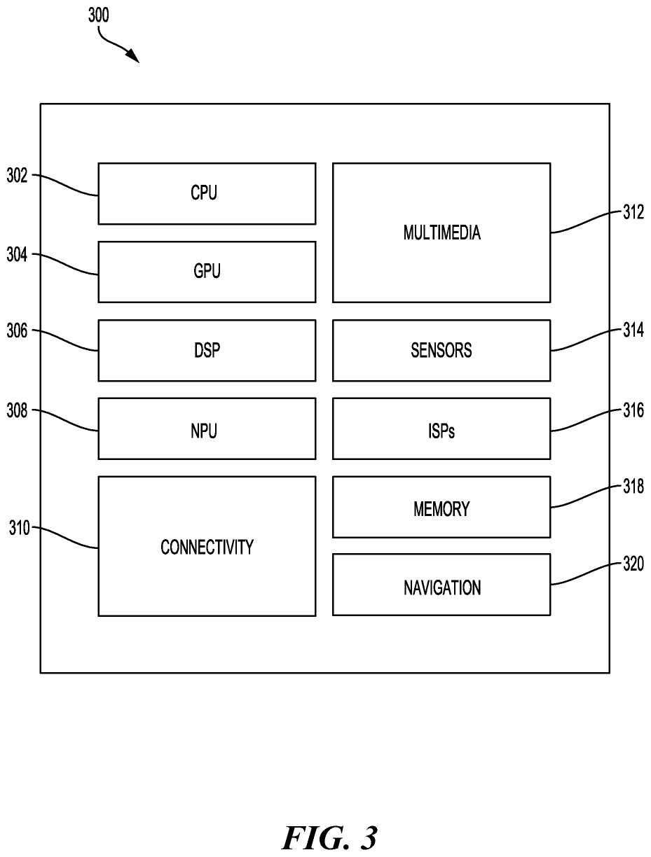

FIG. 3 illustrates an example implementation of a system-on-a-chip (SOC) 300, which may include a central processing unit (CPU) 302 or a multi-core CPU configured for generating gradients for neural network training, in accordance with certain aspects of the present disclosure. The SOC 300 may be included in the base station 110 or UE 120. Variables (for example neural signals and synaptic weights), system parameters associated with a computational device (for example neural network with weights), delays, frequency bin information, and task information may be stored in a memory block associated with a neural processing unit (NPU) 308, in a memory block associated with a CPU 302, in a memory block associated with a graphics processing unit (GPU) 304, in a memory block associated with a digital signal processor (DSP) 306, in a memory block 318, or may be distributed across multiple blocks. Instructions executed at the CPU 302 may be loaded from a program memory associated with the CPU 302 or may be loaded from a memory block 318.

The SOC 300 may also include additional processing blocks tailored to specific functions, such as a GPU 304, a DSP 306, a connectivity block 310, which may include fifth generation (5G) connectivity, fourth generation long term evolution (4G LTE) connectivity, Wi-Fi connectivity, USB connectivity, Bluetooth connectivity, and the like, and a multimedia processor 312 that may, for example, detect and recognize gestures. In one implementation, the NPU is implemented in the CPU, DSP, and/or GPU. The SOC 300 may also include a sensor processor 314, image signal processors (ISPs) 316, and/or navigation module 320, which may include a global positioning system.

The SOC 300 may be based on an ARM instruction set. In an aspect of the present disclosure, the instructions loaded into the general-purpose processor 302 may comprise code to receive, from a base station, a RS on a set of REs; estimate, via a channel estimation neural network, a channel based on receiving the RS; and transmit, to the base station, a feedback report associated with the estimated channel based on receiving the RS.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

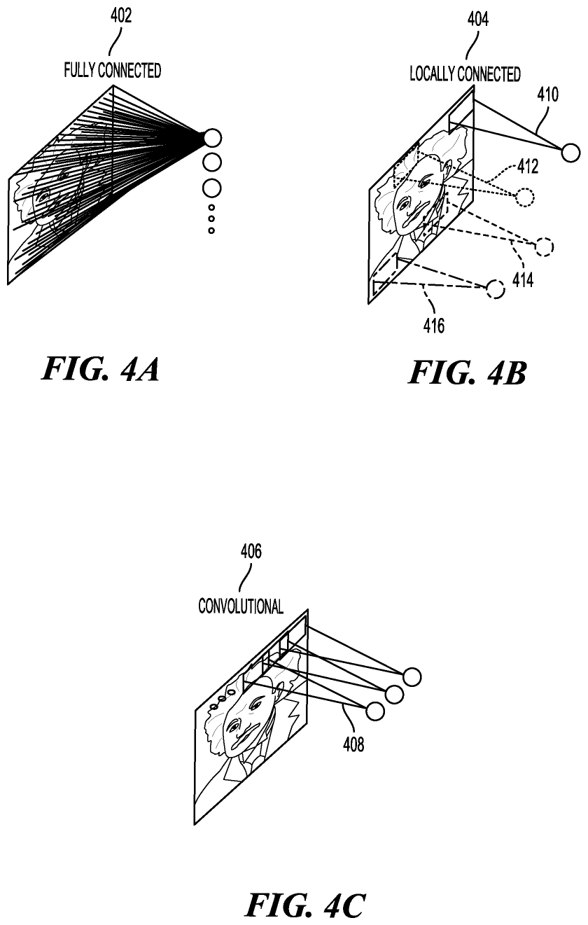

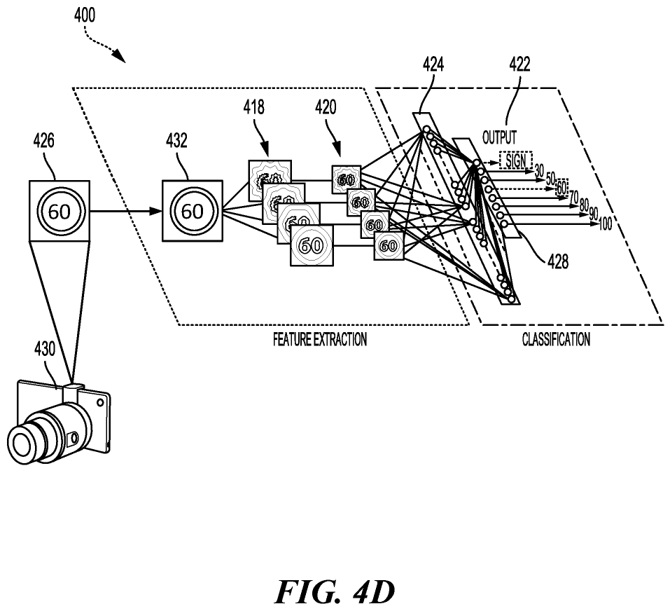

The connections between layers of a neural network may be fully connected or locally connected. FIG. 4A illustrates an example of a fully connected neural network 402. In a fully connected neural network 402, a neuron in a first layer may communicate its output to every neuron in a second layer, so that each neuron in the second layer will receive input from every neuron in the first layer. FIG. 4B illustrates an example of a locally connected neural network 404. In a locally connected neural network 404, a neuron in a first layer may be connected to a limited number of neurons in the second layer. More generally, a locally connected layer of the locally connected neural network 404 may be configured so that each neuron in a layer will have the same or a similar connectivity pattern, but with connections strengths that may have different values (for example 410, 412, 414, and 416). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 4C illustrates an example of a convolutional neural network 406. The convolutional neural network 406 may be configured such that the connection strengths associated with the inputs for each neuron in the second layer are shared (for example 408). Convolutional neural networks may be well suited to problems in which the spatial location of inputs is meaningful.

One type of convolutional neural network is a deep convolutional network (DCN). FIG. 4D illustrates a detailed example of a DCN 400 designed to recognize visual features from an image 426 input from an image capturing device 430, such as a car-mounted camera. The DCN 400 of the current example may be trained to identify traffic signs and a number provided on the traffic sign. Of course, the DCN 400 may be trained for other tasks, such as identifying lane markings or identifying traffic lights.

The DCN 400 may be trained with supervised learning. During training, the DCN 400 may be presented with an image, such as the image 426 of a speed limit sign, and a forward pass may then be computed to produce an output 422. The DCN 400 may include a feature extraction section and a classification section. Upon receiving the image 426, a convolutional layer 432 may apply convolutional kernels (not shown) to the image 426 to generate a first set of feature maps 418. As an example, the convolutional kernel for the convolutional layer 432 may be a 5×5 kernel that generates 28×28 feature maps. In the present example, because four different feature maps are generated in the first set of feature maps 418, four different convolutional kernels were applied to the image 426 at the convolutional layer 432. The convolutional kernels may also be referred to as filters or convolutional filters.

The first set of feature maps 418 may be subsampled by a max pooling layer (not shown) to generate a second set of feature maps 420. The max pooling layer reduces the size of the first set of feature maps 418. That is, a size of the second set of feature maps 420, such as 14×14, is less than the size of the first set of feature maps 418, such as 28×28. The reduced size provides similar information to a subsequent layer while reducing memory consumption. The second set of feature maps 420 may be further convolved via one or more subsequent convolutional layers (not shown) to generate one or more subsequent sets of feature maps (not shown).

In the example of FIG. 4D, the second set of feature maps 420 is convolved to generate a first feature vector 424. Furthermore, the first feature vector 424 is further convolved to generate a second feature vector 428. Each feature of the second feature vector 428 may include a number that corresponds to a possible feature of the image 426, such as “sign,” “60,” and “100.” A softmax function (not shown) may convert the numbers in the second feature vector 428 to a probability. As such, an output 422 of the DCN 400 is a probability of the image 426 including one or more features.

In the present example, the probabilities in the output 422 for “sign” and “60” are higher than the probabilities of the others of the output 422, such as “30,” “40,” “50,” “70,” “80,” “90,” and “100”. Before training, the output 422 produced by the DCN 400 is likely to be incorrect. Thus, an error may be calculated between the output 422 and a target output. The target output is the ground truth of the image 426 (for example “sign” and “60”). The weights of the DCN 400 may then be adjusted so the output 422 of the DCN 400 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images (for example the speed limit sign of the image 426) and a forward pass through the network may yield an output 422 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (for example 220) receiving input from a range of neurons in the previous layer (for example feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

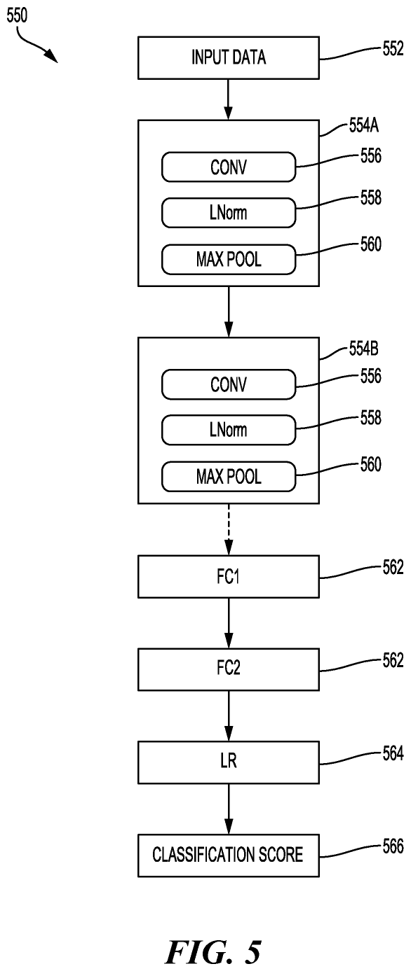

FIG. 5 is a block diagram illustrating a deep convolutional network 550. The deep convolutional network 550 may include multiple different types of layers based on connectivity and weight sharing. As shown in FIG. 5, the deep convolutional network 550 includes the convolution blocks 554A, 554B. Each of the convolution blocks 554A, 554B may be configured with a convolution layer (CONV) 356, a normalization layer (LNorm) 558, and a max pooling layer (MAX POOL) 560.

The convolution layers 556 may include one or more convolutional filters, which may be applied to the input data to generate a feature map. Although only two of the convolution blocks 554A, 554B are shown, the present disclosure is not so limiting, and instead, any number of the convolution blocks 554A, 554B may be included in the deep convolutional network 550 according to design preference. The normalization layer 558 may normalize the output of the convolution filters. For example, the normalization layer 558 may provide whitening or lateral inhibition. The max pooling layer 560 may provide down sampling aggregation over space for local invariance and dimensionality reduction.

The parallel filter banks, for example, of a deep convolutional network may be loaded on a CPU 302 or GPU 304 of an SOC 300 to achieve high performance and low power consumption. In alternative embodiments, the parallel filter banks may be loaded on the DSP 306 or an ISP 316 of an SOC 300. In addition, the deep convolutional network 550 may access other processing blocks that may be present on the SOC 300, such as sensor processor 314 and navigation module 320, dedicated, respectively, to sensors and navigation.

The deep convolutional network 550 may also include one or more fully connected layers 562 (FC1 and FC2). The deep convolutional network 550 may further include a logistic regression (LR) layer 564. Between each layer 556, 558, 560, 562, 564 of the deep convolutional network 550 are weights (not shown) that are to be updated. The output of each of the layers (for example 556, 558, 560, 562, 564) may serve as an input of a succeeding one of the layers (for example 556, 558, 560, 562, 564) in the deep convolutional network 550 to learn hierarchical feature representations from input data 552 (for example images, audio, video, sensor data and/or other input data) supplied at the first of the convolution blocks 554A. The output of the deep convolutional network 550 is a classification score 566 for the input data 552. The classification score 566 may be a set of probabilities, where each probability is the probability of the input data, including a feature from a set of features.

As discussed, in some wireless communication systems, an RS, such as a CSI-RS, may be multiplexed based on a non-orthogonal cover code to reduce an amount of resources used for transmitting the RS. In some examples, a group of ports Nₜ, specified for transmitting the RS, may be multiplexed onto a group of resource elements L, where a number of resource elements in the group of resource elements is less than a number of ports in the group of ports (L<Nₜ). The RS multiplexed based on the non-orthogonal cover code may be associated with compressive sensing (CS)-based CSF reporting or neural network (NN)-based CSF reporting. In such wireless communication systems, a new CSF reporting scheme may be specified for the CS-based CSF reporting and the NN-based CSF reporting.

Various aspects of the present disclosure relate generally to the NN-based CSF reporting. Some aspects more specifically relate to a CSF reporting scheme for RSs, such as CSI-RSs, transmitted on a reduced number of resources. In such aspects, a base station multiplexes an RS based on a non-orthogonal cover code and transmits the multiplexed RS to the UE. An artificial neural network at the UE may then estimate a channel between the base station and the UE based on the received RS. For ease of explanation, the artificial neural network used to estimate the channel may be referred to as the channel estimation neural network or the channel estimation network. Additionally, a CSI reporting scheme will be used to describe the CSF reporting of the various aspects of the present disclosure. Other types of CSF reporting schemes are contemplated.

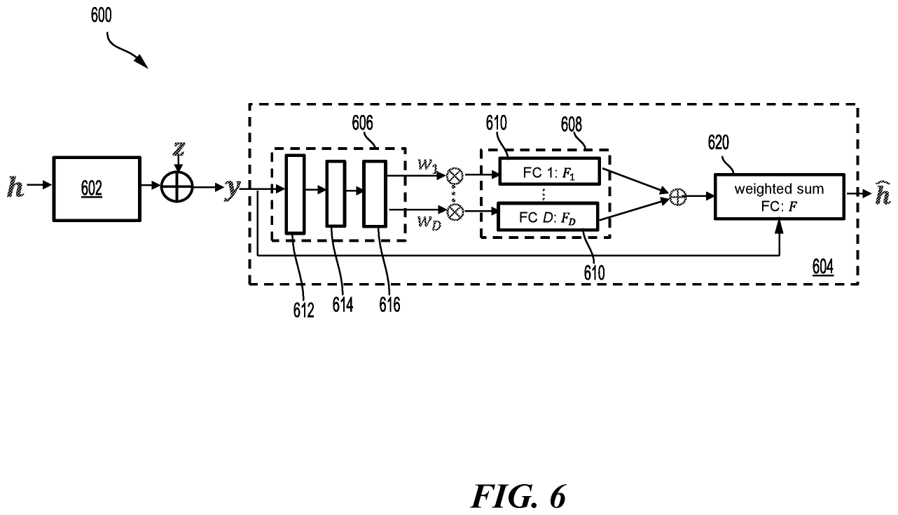

FIG. 6 is a block diagram illustrating an example of an artificial neural network 600, in accordance with aspects of the present disclosure. As shown in the example of FIG. 6, the artificial neural network 600 includes a cover code block 602 and a channel estimation neural network 604. The cover code block 602 may be implemented as a one-dimensional (1D) grouped convolutional layer that applies a non-orthogonal cover code to a channel h. The output of the cover code block 602 may be summed with a variable Z to generate a reference signal y, such as a CSI-RS. The variable Z represents noise associated with an RS transmission. Additionally, the channel estimation neural network 604 includes a classification block 606 and a neural network pool 608.

In the example of FIG. 6, the classification block 606 includes a fully connected (FC) layer with a rectified linear unit (ReLU) activation function 612, another FC layer 614, and a softmax layer 616. The classification block 606 may include additional layers that are not shown in FIG. 6. In some examples, the classification block 606 generates a classification score wᵢ for each channel statistic i associated with the reference signal y, where the variable i is a value from 1 to D. Each classification score wᵢ may be an example of a probability vector. The softmax layer 616 receives a classification score for each channel statistic i and normalizes these values by dividing them by the sum of all classification scores, such that a sum of all classification scores wᵢ output by the softmax layer 616 equals one.

Additionally, as shown in FIG. 6, the neural network pool 608 includes a quantity D of fully connected (FC) layers 610. The quantity D of FC layers 610 may be determined during a training stage of the channel estimation neural network 604. Each FC layer 610 in the neural network pool 608 corresponds to a respective channel statistic i of the reference signal y input to the channel estimation neural network 604. An FC layer associated with a respective channel statistic i of the reference signal y may be activated when a classification score wᵢ associated with the respective channel statistic i is greater than or equal to a classification value. Each FC layer 610 may be associated with a FC parameter Fᵢ. A product wᵢFᵢ associated with activated FC layer 610 may be summed at a weighted sum layer 620 that is specified to generate a weighted sum F. In some examples, the channel estimation neural network 604 may mimic a linear estimator, such that the estimated channel ĥ is a product of the reference signal y received at the weighted sum layer 620 and the weighted sum F generated at the weighted sum layer 620 (for example, ĥ=Fy), where the linear estimator F=Σᵢ₌₁^{D}wᵢFᵢ. The channel estimation neural network 604 may approximate a linear minimum mean square error (LMMSE) estimator, where each FC layer 610 may correspond to an LMMSE estimator for one channel statistic i.

As discussed, in some implementations the UE may transmit, to the base station, a feedback report associated with the channel based on receiving the RS. In some examples, the feedback report indicates one or more quantized values associated with the reference signal. In such examples, an artificial neural network, at the base station, may process the one or more quantized values to estimate the channel between the base station and the UE.

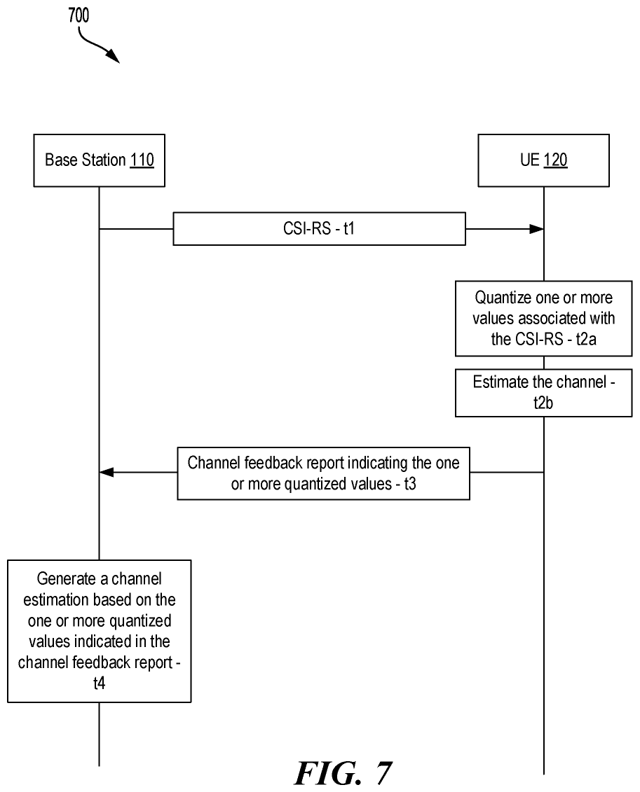

FIG. 7 is a timing diagram illustrating an example 700 of reporting a quantized reference signal, in accordance with various aspects of the present disclosure. In the example 700 of FIG. 7, a base station 110 may generate a reference signal, such as a CSI-RS, that is multiplexed based on a non-orthogonal cover code. In some examples, a one-dimensional (1D) convolutional neural network may generate the CSI-RS, which is multiplexed based on a cover code. The 1D convolutional neural network may have been trained to generate the CSI-RS that is multiplexed based on a non-orthogonal cover code. For ease of explanation, the example 700 of FIG. 7 will be described using a CSI-RS.

As shown in FIG. 7, at time t1, the base station 110 transmits the CSI-RS y that is multiplexed based on a cover code to a UE 120. The CSI-RS y may be transmitted on a channel h between the UE 120 and the base station 110. The UE 120 may receive the CSI-RS y and quantize one or more values associated with the CSI-RS y at time t2a. In some examples, the UE 120 quantizes an amplitude a and a phase θ of the CSI-RS y. In such examples, the CSI-RS y may be a product of the amplitude a and the phase θ, such that yᵢ=ae^{jθ}, where yᵢ is one scalar in a vector y and the parameter e represents an exponential constant. In some other examples, the CSI-RS y may be represented as a complex number, such that yᵢ=c+jd, where the parameter c represents a real part, the parameter d represents the imaginary part, and the parameter j=\sqrt{−1}. In such examples, the UE may quantize the real part c and the imaginary part d. At time t2b, the UE 120 may recover the channel h based on receiving the CSI-RS. In some examples, the channel h may be recovered using a channel estimation neural network, such as the channel estimation neural network 604 described with reference to FIG. 6. In such examples, the UE 120 inputs the CSI-RS y to the channel estimation neural network to recover the channel h.

At time t3, the UE may transmit a feedback report, such as a CSI report, indicating the quantized values associated with a measurement of the CSI-RS. The CSI report may indicate the quantized values associated with the measurement of CSI-RS based on a size of the quantized values being equal to or less than a size of an available payload of the feedback report. In some examples, the feedback report indicates the quantized amplitude â and the quantized phase \hat{θ}. In some such examples, the base station 110 may use the quantized amplitude â and the quantized phase \hat{θ} in a function associated with a measurement of the CSI-RS, such as yᵢ=âe^{j\hat{θ}}, to recover the CSI-RS y. In some other examples, the feedback report indicates the quantized real part ĉ and the quantized imaginary part \hat{d} of a value of a measurement of the CSI-RS y, such that the CSI-RS y may be recovered based on the quantized real part ĉ and the quantized imaginary part \hat{d} (for example, yᵢ=ĉ+j\hat{d}). At time t4, the base station 110 may generate a channel estimation ĥ based on the recovered CSI-RS y or the quantized CSI-RS ŷ. The estimated channel ĥ may be an estimation of the channel h between the base station 110 and the UE 120. In some examples, the base station 110 may use a channel estimation neural network, such as the channel estimation neural network 604 described with reference to FIG. 6, to generate the channel estimation ĥ.

As discussed, some aspects relate to a CSI reporting scheme for reference signals, such as CSI-RSs, transmitted on a reduced number of resources. In some other examples, the feedback report indicates parameters associated with the channel estimated by the artificial neural network, at the UE. In such examples, the channel may be estimated based on a codebook associated with the channel estimation neural network. Additionally, the base station may recover the channel based on the parameters indicated by the feedback report.

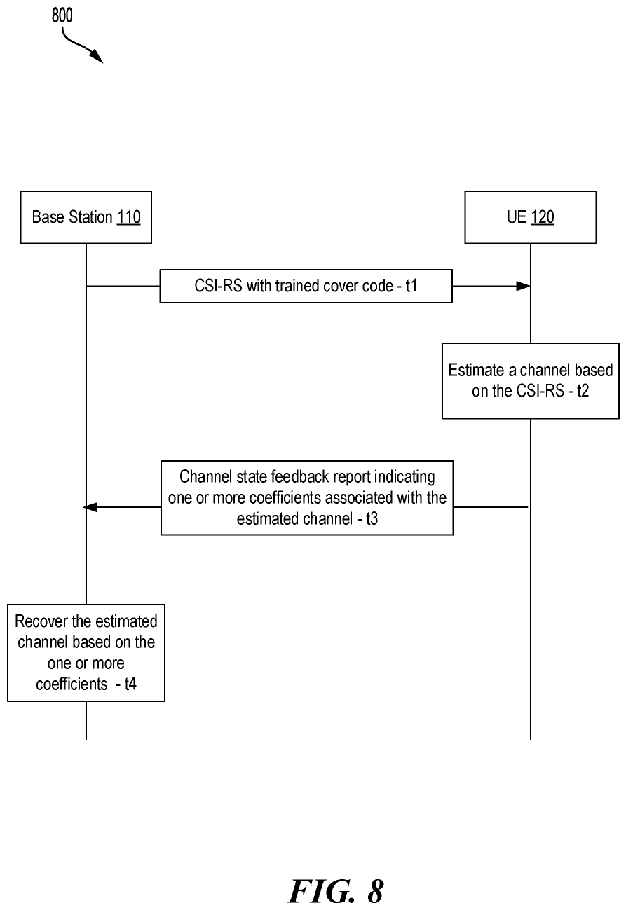

FIG. 8 is a timing diagram illustrating an example 800 of reporting a quantized reference signal, in accordance with various aspects of the present disclosure. In the example 800 of FIG. 8, a base station 110 may generate a reference signal, such as a CSI-RS, that is multiplexed based on a non-orthogonal cover code. In some examples, 1D convolutional neural network may have been trained to generate the non-orthogonal cover code. In such examples, the trained 1D convolutional neural network may generate the non-orthogonal cover code used to multiplex the CSI-RS. For ease of explanation, the example 800 of FIG. 8 will be described using a CSI-RS.

As shown in FIG. 8, at time t1, the base station 110 transmits the CSI-RS y that is multiplexed based on a cover code to a UE 120. The CSI-RS y may be transmitted on a channel h between the UE 120 and the base station 110. At time t2, the UE 120 generates a channel estimation ĥ based on the CSI-RS y received at time t1. In some examples, the UE 120 may use a channel estimation neural network, such as the channel estimation neural network 604 described with reference to FIG. 6, to generate the channel estimation ĥ. In the example 800 of FIG. 8, the channel estimation neural network may generate the channel estimation ĥ based on a codebook associated with the channel estimation neural network. A codebook associated with the channel estimation neural network for generating the estimated channel ĥ may be represented as Ua (for example, ĥ=Ua), where the parameter ĥ is an aggregation of each channel hᵢ, from i=i to Nᵣ, within a wideband channel, and ĥ=[h₁; h₂; . . . ; h_{N}_{ᵣ}], where ĥ has a size SNᵣ by 1. Specifically, the parameter hᵢ represents a channel on an i-th receiving antenna of the UE 120, where the parameter Nᵣ represents a total number of antennas at the UE 120 and hᵢ is a complex number having a size S by 1. In such examples, the UE 120 may receive a channel on each antenna of a number of antennas (1 to Nᵣ). Additionally, the parameter U represents a matrix having a block diagonal structure, where U∈C^{SN}^{ᵣ}^{×M} and M represents a basis, such that M=Σᵢ₌₁^{N}^{ᵣ}Mᵢ and the matrix U is a linear combination of the basis M. Furthermore, the parameter a represents linear combination coefficients, where a∈C^{M}. Specifically, a=[a¹, a², . . . , a^{N}^{ᵣ}]^{T}∈C^{M}, where aⁱ=[a₁ⁱ, a₂ⁱ, . . . , a_{M}_{ᵢ}ⁱ]^{T}∈C^{M}^{ᵢ} is a linear combination coefficient for Ūᵢ to recover a channel (ĥᵢ) of an i-th antenna (for example, ĥᵢ=Ūᵢaⁱ).

The matrix U may be represented as:

$$U = ( \begin{matrix}{\overline{U}}_{1} & 0 & … & 0 \\ 0 & {\overline{U}}_{2} & & 0 \\ ⋮ & & ⋱ & ⋮ \\ 0 & 0 & … & {\overline{U}}_{{N}_{T}}\end{matrix} ) , \qquad ( 1 )$$

where Ūᵢ∈C^{S×M}^{ᵢ} is a linear combination of D basis. In some examples, Ūᵢ=Σⱼ^{D}cⱼⁱBⱼ, where the parameter Bⱼ is one basis of Ūᵢ and may be associated with the channel estimation neural network, and the parameter cⱼⁱ represents linear combination coefficients. In such examples, a group of D basis (for example, Bⱼ) may be stored at both the base station 110 and the UE 120. The group of D basis may be referred to as a pool of D basis or a basis pool D.

In the example 800 of FIG. 8, at time t2, the channel estimation neural network may generate the matrix U using a basis pool D, where basis linear combination coefficients C may be determined based on a wᵢ associated with each fully connected layer, such as the FC layer 610 described in FIG. 6. The estimated channel ĥ may be projected to the matrix U to determine the linear combination coefficients a. In some examples, the linear combination coefficients a may be a product of the estimated channel ĥ and a transpose T of the matrix U (for example, a=U^{T}ĥ or aᵢ=Uᵢ^{T}ĥᵢ).

At time t3, the UE 120 may transmit a channel state feedback report, such as a CSI report, indicating one or more coefficients associated with the estimated channel ĥ. In some examples, the channel state feedback report indicates basis linear combination coefficients C, where C={c₁¹, c₂¹, . . . , c_{D}¹, c₁², c₂², . . . , c₁^{N}^{ᵣ}, c₂^{N}^{ᵣ}, . . . , c_{D}^{N}^{ᵣ}}, and also linear combination coefficients a, where a=[a¹, a², . . . , a^{N}^{ᵣ}]^{T}∈C^{M} with aⁱ=[a₁ⁱ, a₂ⁱ, . . . , a_{M}_{ᵢ}ⁱ]^{T}. The linear combination coefficients a may also be referred to as matrix linear combination coefficients a. The basis linear combination coefficients C may be used to determine the variables Ūᵢ in the diagonal block of the matrix U.

In some examples, the basis linear combination coefficients C may be reported using a bitmap having a length DNᵣ. In such examples, the basis linear combination coefficients C may be a selection vector that is used to select a basis (for example, Bⱼ) in the pool of basis D. In some other examples, the UE 120 may quantize all values of the linear combination coefficients C with Q_{C} bits in total. The UE 120 may then report all Q_{C} bits. In still other examples, the UE 120 may select a number P of dominant values from the linear combination coefficients C to report with a total Q_{P}-bit quantization. In such examples, the UE 120 may also report a position indicator indicating the positions of the number P of dominant values out of D positions. In some such examples, the position indicator may be a DNᵣ-length bitmap, such that a size of the report for the basis linear combination coefficients C is at least Q_{P}+DNᵣ bits. In some other examples, the position indicator may be P×ceil(log₂ D), such that a size of the report for the basis linear combination coefficients C is at least Q_{P}+P×ceil(log₂ D) bits, where ceil(log₂ D) is a function for rounding log₂ D to a next largest integer.

Additionally, in some examples, the channel state feedback report may indicate all basis M values in the linear combination coefficients a with a Qₐ-bit quantization in total. In some other examples, M values in a with Qₐ-bit quantization in total K (K<M) coefficients in the linear combination coefficients a with Q_{K}-bit quantization and a position indicator, where K=Σᵢ₌₁^{N}^{ᵣ}Kᵢ with Kᵢ<Mᵢ, such that a quantity Kᵢ is selected from the Mᵢ values in the linear combination coefficients aⁱ associated with the variables Ūᵢ in the diagonal block of the matrix U. In some such examples, the position indicator is a bitmap with a length equal to a value of the parameter M, such that a size of the report for the linear combination coefficients a is at least Q_{K}+M bits. In other such examples, the position indicator may include Nᵣ blocks with each block indicating the Kᵢ values' positions using Kᵢ×ceil(log₂ Mᵢ) bits, such that a size of the report for the linear combination coefficients a is at least Q_{K}+Σᵢ₌₁^{N}^{ᵣ}Kᵢ×ceil(log₂ Mᵢ) bits.

In the example of 800 of FIG. 8, at time t4, the base station 110 may recover the estimated channel ĥ based on the basis linear combination coefficients C and the linear combination coefficients a indicated in the channel state feedback report. In some examples, the base station 110 reconstructs the matrix U based on the basis linear combination coefficients C and the basis pool D. In some such examples, the base station 110 may generate each diagonal block value Ūᵢ of the matrix U based on a basis channel combination coefficient cⱼⁱ obtained from the basis linear combination coefficients C, and also a basis Bⱼ from the basis pool D, where Ūᵢ=Σⱼ^{D}cⱼⁱBⱼ. After reconstructing the matrix U, the base station may recover the estimated channel ĥ based on the matrix U and the linear combination coefficients a (for example, ĥ=Ua).

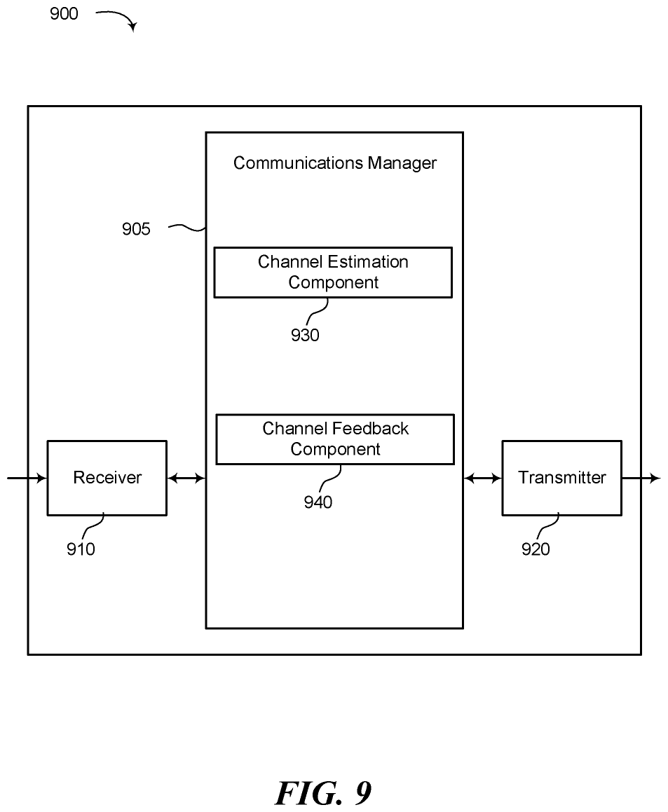

FIG. 9 is a block diagram illustrating an example wireless communication device 900 that supports NN-based CSF reporting, in accordance with some aspects of the present disclosure. The device 900 may be an example of aspects of a UE 120 described with reference to FIGS. 1, 2, 7, and 8. The wireless communications device 900 may include a receiver 910, a communications manager 905, a transmitter 920, a channel estimation component 930, and a channel feedback component 940, which may be in communication with one another (for example, via one or more buses). In some examples, the wireless communications device 900 is configured to perform operations, including operations of the process 1000 described below with reference to FIG. 10.

In some examples, the wireless communications device 900 can include a chip, chipset, package, or device that includes at least one processor and at least one modem (for example, a 5G modem or other cellular modem). In some examples, the communications manager 905, or its sub-components, may be separate and distinct components. In some examples, at least some components of the communications manager 905 are implemented at least in part as software stored in a memory. For example, portions of one or more of the components of the communications manager 905 can be implemented as non-transitory code executable by the processor to perform the functions or operations of the respective component.

The receiver 910 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communications devices via various channels including control channels (for example, a physical downlink control channel (PDCCH) or physical uplink control channel (PUCCH)) and data channels (for example, a physical downlink shared channel (PDSCH) or a physical uplink shared channel (PUSCH)). The other wireless communications devices may include, but are not limited to, a base station 110 described with reference to FIGS. 1, 2, 7, and 8.

The received information may be passed on to other components of the device 900. The receiver 910 may be an example of aspects of the receive processor 238, 258 described with reference to FIG. 2. The receiver 910 may include a set of radio frequency (RF) chains that are coupled with or otherwise utilize a set of antennas (for example, the set of antennas may be an example of aspects of the antennas 252a, 234a through 252r, 234t described with reference to FIG. 2).

The transmitter 920 may transmit signals generated by the communications manager 905 or other components of the wireless communications device 900. In some examples, the transmitter 920 may be collocated with the receiver 910 in a transceiver. The transmitter 920 may be an example of aspects of the transmit processor 220, 264 described with reference to FIG. 2. The transmitter 920 may be coupled with or otherwise utilize a set of antennas (for example, the set of antennas may be an example of aspects of the antennas 252a, 234a through 252r, 234t described with reference to FIG. 2), which may be antenna elements shared with the receiver 910. In some examples, the transmitter 920 is configured to transmit control information in a PUCCH or PDCCH and data in a physical uplink shared channel (PUSCH) or PDSCH.

The communications manager 905 may be an example of aspects of the controller/processor 240, 280 described with reference to FIG. 2. The communications manager 905 may include channel estimation component 930 and the channel feedback component 940. Working with the receiver 910, the channel estimation component 930 receives, from a base station, a RS on a set of REs. The RS may be multiplexed onto the set of REs based on a non-orthogonal cover code. In some examples, a number of REs in the set of REs is less than a number of ports associated with the RS based on the multiplexing by the non-orthogonal cover code. Additionally, the channel estimation component 930 may estimate, via a channel estimation neural network, a channel based on receiving the RS. Furthermore, working in conjunction with the transmitter 920 and the channel estimation component 930, the channel feedback component 940 may transmit, to the base station, a feedback report associated with the estimated channel based on receiving the RS.

FIG. 10 is a flow diagram illustrating an example process 1000 performed, for example, by a user equipment (UE), in accordance with various aspects of the present disclosure. The example process 1000 is an example of a NN-based CSF scheme. As shown in FIG. 10, the process 1000 begins at block 1002 by receiving, from a base station, a RS on a set of REs. The RS may be multiplexed onto the set of REs based on a non-orthogonal cover code. In some examples, a number of REs in the set of REs is less than a number of ports associated with the RS based on the multiplexing by the non-orthogonal cover code. The RS may be an CSI-RS. At block 1004, the process 1000 estimates, at the UE via a channel estimation neural network, a channel based on receiving the RS. At block 1006, the process 1000 transmits, to the base station, a feedback report associated with the estimated channel based on receiving the RS.

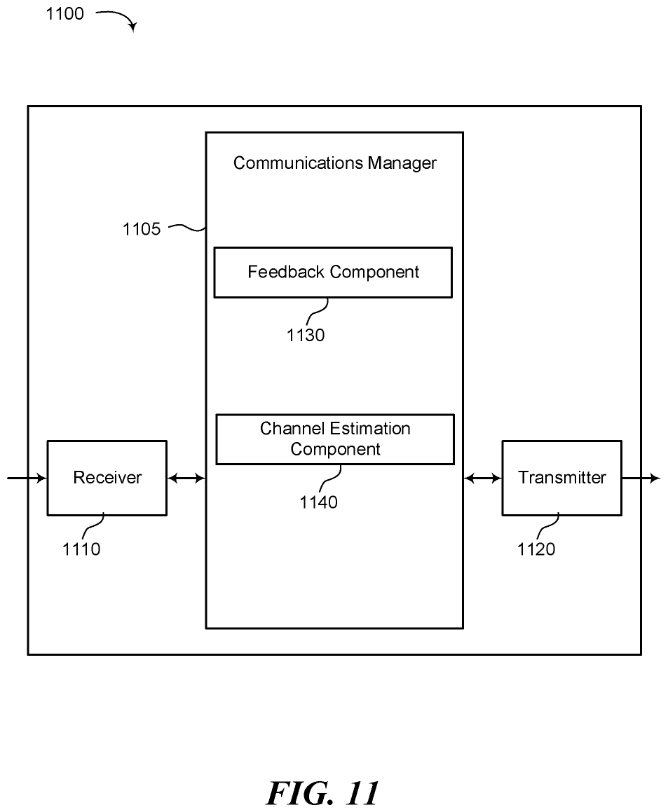

FIG. 11 is a block diagram illustrating an example wireless communication device 1100 that supports NN-based CSF reporting, in accordance with aspects of the present disclosure. The wireless communication device 1100 may be an example of aspects of a base station 110 described with reference to FIGS. 1, 2, 7, and 8. The wireless communication device 1100 may include a receiver 1110, a communications manager 1115, and a transmitter 1120, which may be in communication with one another (for example, via one or more buses). In some examples, the wireless communication device 1100 is configured to perform operations, including operations of the process 1000 described below with reference to FIG. 10.

In some examples, the wireless communication device 1100 can include a chip, system on chip (SOC), chipset, package, or device that includes at least one processor and at least one modem (for example, a 5G modem or other cellular modem). In some examples, the communications manager 1115, or its sub-components, may be separate and distinct components. In some examples, at least some components of the communications manager 1115 are implemented at least in part as software stored in a memory. For example, portions of one or more of the components of the communications manager 1115 can be implemented as non-transitory code executable by the processor to perform the functions or operations of the respective component.

The receiver 1110 may receive one or more reference signals (for example, periodically configured CSI-RSs, aperiodically configured CSI-RSs, or multi-beam-specific reference signals), synchronization signals (for example, synchronization signal blocks (SSBs)), control information, and/or data information, such as in the form of packets, from one or more other wireless communication devices via various channels including control channels (for example, a PDCCH) and data channels (for example, a PDSCH). The other wireless communication devices may include, but are not limited to, another base station 110 or a UE 120, described with reference to FIGS. 1 and 2.

The received information may be passed on to other components of the wireless communication device 1100. The receiver 1110 may be an example of aspects of the receive processor 238 described with reference to FIG. 2. The receiver 1110 may include a set of radio frequency (RF) chains that are coupled with or otherwise utilize a set of antennas (for example, the set of antennas may be an example of aspects of the antennas 234a through 234t described with reference to FIG. 2).

The transmitter 1120 may transmit signals generated by the communications manager 1115 or other components of the wireless communication device 1100. In some examples, the transmitter 1120 may be collocated with the receiver 1110 in a transceiver. The transmitter 1120 may be an example of aspects of the transmit processor 220 described with reference to FIG. 2. The transmitter 1120 may be coupled with or otherwise utilize a set of antennas (for example, the set of antennas may be an example of aspects of the antennas 234a through 234t), which may be antenna elements shared with the receiver 1110. In some examples, the transmitter 1120 is configured to transmit control information in a physical uplink control channel (PUCCH) and data in a physical uplink shared channel (PUSCH).

The communications manager 1115 may be an example of aspects of the controller/processor 240 described with reference to FIG. 2. The communications manager 1115 includes a feedback component 1130 and a channel estimation component 1140. Working in conjunction with the transmitter 1120, the channel estimation component 1140 may multiplex an RS on onto a set of REs based on a non-orthogonal cover code. A number of REs in the set of REs may be less than a number of antenna ports associated with the RS. Additionally, working in conjunction with the transmitter, the channel estimation component 1140 may transmit, to the UE, the RS on the set of REs. Working in conjunction with the receiver 1110, the feedback component 1130 may receive, from the UE, a feedback report associated with the RS and recover an estimate of a channel associated with the RS based on receiving the feedback report.

FIG. 12 is a flow diagram illustrating an example process 1200 performed, for example, by a base station, in accordance with various aspects of the present disclosure. The example process 1200 is an example of a NN-based CSF scheme. As shown in FIG. 12, the process 1200 begins at block 1202 by multiplexing a reference signal on onto a set of resource elements based on a non-orthogonal cover code, a number of REs in the set of REs being less than a number of antenna ports associated with the RS. At block 1204, the process 1200 transmits, to a UE, the RS on the set of REs receiving, from the UE, a feedback report associated with the RS. At block 1206, the process 1200 receives, from the UE, a feedback report associated with the RS. At block 1208, the process 1200 recovers, at the base station, an estimate of a channel associated with the RS based on receiving the feedback report.

Implementation examples are described in the following numbered clauses.
Clause 1. A method for wireless communication at a UE, comprising: receiving, from a base station, a RS on a set of REs, the RS having been multiplexed onto the set of REs based on a non-orthogonal cover code, a number of REs in the set of REs being less than a number of ports associated with the RS; estimating, at the UE via a channel estimation neural network, a channel based on receiving the RS; and transmitting, to the base station, a feedback report associated with the estimated channel based on receiving the RS.
Clause 2. The method of Clause 1, further comprising quantizing one or more values associated with a measurement of the RS, wherein the feedback report indicates the one or more quantized values associated with the RS.
Clause 3. The method of Clause 2, wherein the one or more quantized values include both a quantized amplitude of the measurement of the RS and a quantized phase of the measurement of the RS.
Clause 4. The method of Clause 2, wherein: a value of the measurement of the RS is a complex number; and the one or more quantized values include both a quantized real value of the measurement of the RS and a quantized imaginary real value of the measurement of the RS.
Clause 5. The method of Clause 1, wherein the feedback report indicates a first group of channel coefficients and a second group of channel coefficients associated with a codebook used by the channel estimation neural network.
Clause 6. The method of Clause 5, wherein: the first group of channel coefficients are linear combination coefficients associated with variables of a diagonal block of a matrix associated with the codebook; and the second group of channel coefficients are linear combination coefficients associated with the matrix.
Clause 7. The method of Clause 6, wherein: each channel coefficient of the first group of channel coefficients corresponds to a classification score associated with a respective channel statistic of a plurality of channel statistics associated with the RS; each channel coefficient of the first group of channel coefficients is associated with a single respective antenna of a group of receiving antennas of the UE; and a value of each channel coefficient of the first group of channel coefficients is a product of the estimated channel associated with a respective antenna of the group of antennas and a transpose of a matrix associated with the codebook.
Clause 8. A method for wireless communication at base station, comprising: multiplexing a reference signal on onto a set of resource elements based on a non-orthogonal cover code, a number of REs in the set of REs being less than a number of antenna ports associated with the RS; transmitting, to a UE, the RS on the set of REs; receiving, from the UE, a feedback report associated with the RS; and recovering, at the base station, an estimate of a channel associated with the RS based on receiving the feedback report.
Clause 9. The method of Clause 8, wherein: the feedback report indicates one or more quantized values associated with a measurement of the RS; and the estimate of the channel is recovered by a channel estimation neural network based on the one or more quantized values.
Clause 10. The method of Clause 9, wherein the one or more quantized values include both a quantized amplitude of the measurement of the RS and a quantized phase of the measurement of the RS.
Clause 11. The method of Clause 9, wherein: a value of the measurement of the RS is a complex number; and the one or more quantized values include both a quantized real value of the measurement of the RS and a quantized imaginary real value of the measurement of the RS.
Clause 12. The method of Clause 8, wherein the feedback report indicates a first group of channel coefficients and a second group of channel coefficients associated with a codebook used by a channel estimation neural network of the UE to estimate the channel.
Clause 13. The method of Clause 12, wherein: the first group of channel coefficients are linear combination coefficients associated with variables of a diagonal block of a matrix associated with the codebook; and the second group of channel coefficients are linear combination coefficients associated with the matrix.
Clause 14. The method of Clause 13, wherein: each channel coefficient of the first group of channel coefficients corresponds to a classification score associated with a respective channel statistic of a plurality of channel statistics associated with the RS; each channel coefficient of the first group of channel coefficients is associated with a single respective antenna of a group of receiving antennas of the UE; and a value of each channel coefficient of the first group of channel coefficients is a product of the estimated channel associated with a respective antenna of the group of antennas and a transpose of a matrix associated with the codebook.
Clause 15. The method of Clause 13, further comprising reconstructing a matrix of the codebook based on a basis pool and the first group of channel coefficients, wherein the estimate of the channel is recovered based on a product of the matrix and the second group of channel coefficients.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication at a user equipment (UE), comprising:
receiving, from a base station, a reference signal (RS) on a set of resource elements (REs), the RS having been multiplexed onto the set of REs based on a non-orthogonal cover code, a number of REs in the set of REs being less than a number of ports associated with the RS;
estimating, at the UE via a channel estimation neural network, a channel based on receiving the RS; and
transmitting, to the base station, a feedback report associated with the estimated channel based on receiving the RS.

2. The method of claim 1, further comprising quantizing one or more values associated with a measurement of the RS, wherein the feedback report indicates the one or more quantized values associated with the RS.

3. The method of claim 2, wherein the one or more quantized values include both a quantized amplitude of the measurement of the RS and a quantized phase of the measurement of the RS.

4. The method of claim 2, wherein:
a value of the measurement of the RS is a complex number; and
the one or more quantized values include both a quantized real value of the measurement of the RS and a quantized imaginary value of the measurement of the RS.

5. The method of claim 1, wherein the feedback report indicates a first group of channel coefficients and a second group of channel coefficients associated with a codebook used by the channel estimation neural network.

6. The method of claim 5, wherein:
the first group of channel coefficients are linear combination coefficients associated with variables of a diagonal block of a matrix associated with the codebook; and
the second group of channel coefficients are linear combination coefficients associated with the matrix.

7. The method of claim 6, wherein:
each channel coefficient of the first group of channel coefficients corresponds to a classification score associated with a respective channel statistic of a plurality of channel statistics associated with the RS;
each channel coefficient of the first group of channel coefficients is associated with a single respective antenna of a group of receiving antennas of the UE; and
a value of each channel coefficient of the first group of channel coefficients is a product of the estimated channel associated with a respective antenna of the group of antennas and a transpose of the matrix.

8. A method for wireless communication at base station, comprising:
multiplexing a reference signal (RS) onto a set of resource elements (REs) based on a non-orthogonal cover code, a number of REs in the set of REs being less than a number of antenna ports associated with the RS;
transmitting, to a user equipment (UE), the RS on the set of REs;
receiving, from the UE, a feedback report associated with the RS; and
recovering, at the base station, an estimate of a channel associated with the RS based on receiving the feedback report.

9. The method of claim 8, wherein:
the feedback report indicates one or more quantized values associated with a measurement of the RS; and
the estimate of the channel is recovered by a channel estimation neural network based on the one or more quantized values.

10. The method of claim 9, wherein the one or more quantized values include both a quantized amplitude of the measurement of the RS and a quantized phase of the measurement of the RS.

11. The method of claim 9, wherein:
a value of the measurement of the RS is a complex number; and
the one or more quantized values include both a quantized real value of the measurement of the RS and a quantized imaginary real value of the measurement of the RS.

12. The method of claim 8, wherein the feedback report indicates a first group of channel coefficients and a second group of channel coefficients associated with a codebook used by a channel estimation neural network of the UE to estimate the channel.

13. The method of claim 12, wherein:
the first group of channel coefficients are linear combination coefficients associated with variables of a diagonal block of a matrix associated with the codebook; and
the second group of channel coefficients are linear combination coefficients associated with the matrix.

14. The method of claim 13, wherein:
each channel coefficient of the first group of channel coefficients corresponds to a classification score associated with a respective channel statistic of a plurality of channel statistics associated with the RS;
each channel coefficient of the first group of channel coefficients is associated with a single respective antenna of a group of receiving antennas of the UE; and
a value of each channel coefficient of the first group of channel coefficients is a product of the estimated channel associated with a respective antenna of the group of antennas and a transpose of the matrix.

15. The method of claim 13, further comprising reconstructing the matrix based on a basis pool and the first group of channel coefficients,
wherein the estimate of the channel is recovered based on a product of the matrix and the second group of channel coefficients.

16. An apparatus for wireless communications at a user equipment (UE), comprising:
a processor;
a memory coupled with the processor; and
instructions stored in the memory and operable, when executed by the processor, to cause the apparatus to:
receive, from a base station, a reference signal (RS) on a set of resource elements (REs), the RS having been multiplexed onto the set of REs based on a non-orthogonal cover code, a number of REs in the set of REs being less than a number of ports associated with the RS;
estimate, at the UE via a channel estimation neural network, a channel based on receiving the RS; and
transmit, to the base station, a feedback report associated with the estimated channel based on receiving the RS.

17. The apparatus of claim 16, wherein execution of the instructions further cause the apparatus to quantize one or more values associated with a measurement of the RS, wherein the feedback report indicates the one or more quantized values associated with the RS.

18. The apparatus of claim 17, wherein the one or more quantized values include both a quantized amplitude of the measurement of the RS and a quantized phase of the measurement of the RS.

19. The apparatus of claim 17, wherein:
a value of the measurement of the RS is a complex number; and
the one or more quantized values include both a quantized real value of the measurement of the RS and a quantized imaginary real value of the measurement of the RS.

20. The apparatus of claim 16, wherein the feedback report indicates a first group of channel coefficients and a second group of channel coefficients associated with a codebook used by the channel estimation neural network.

21. The apparatus of claim 20, wherein:
the first group of channel coefficients are linear combination coefficients associated with variables of a diagonal block of a matrix associated with the codebook; and
the second group of channel coefficients are linear combination coefficients associated with the matrix.

22. The apparatus of claim 21, wherein:
each channel coefficient of the first group of channel coefficients corresponds to a classification score associated with a respective channel statistic of a plurality of channel statistics associated with the RS;
each channel coefficient of the first group of channel coefficients is associated with a single respective antenna of a group of receiving antennas of the UE; and
a value of each channel coefficient of the first group of channel coefficients is a product of the estimated channel associated with a respective antenna of the group of antennas and a transpose of a matrix associated with the codebook.

23. An apparatus for wireless communications at base station, comprising:
a processor;
a memory coupled with the processor; and
instructions stored in the memory and operable, when executed by the processor, to cause the apparatus to:
multiplex a reference signal (RS) on onto a set of resource elements (REs) based on a non-orthogonal cover code, a number of REs in the set of REs being less than a number of antenna ports associated with the RS;
transmit, to a user equipment (UE), the RS on the set of RES;
receive, from the UE, a feedback report associated with the RS; and
recover, at the base station, an estimate of a channel associated with the RS based on receiving the feedback report.

24. The apparatus of claim 23, wherein:
the feedback report indicates one or more quantized values associated with a measurement of the RS; and
the estimate of the channel is recovered by a channel estimation neural network based on the one or more quantized values.

25. The apparatus of claim 24, wherein the one or more quantized values include both a quantized amplitude of the measurement of the RS and a quantized phase of the measurement of the RS.

26. The apparatus of claim 24, wherein:
a value of the measurement of the RS is a complex number; and
the one or more quantized values include both a quantized real value of the measurement of the RS and a quantized imaginary real value of the measurement of the RS.

27. The apparatus of claim 23, wherein the feedback report indicates a first group of channel coefficients and a second group of channel coefficients associated with a codebook used by a channel estimation neural network of the UE to estimate the channel.

28. The apparatus of claim 27, wherein:
the first group of channel coefficients are linear combination coefficients associated with variables of a diagonal block of a matrix associated with the codebook; and
the second group of channel coefficients are linear combination coefficients associated with the matrix.

29. The apparatus of claim 28, wherein:
each channel coefficient of the first group of channel coefficients corresponds to a classification score associated with a respective channel statistic of a plurality of channel statistics associated with the RS;
each channel coefficient of the first group of channel coefficients is associated with a single respective antenna of a group of receiving antennas of the UE; and
a value of each channel coefficient of the first group of channel coefficients is a product of the estimated channel associated with a respective antenna of the group of antennas and a transpose of a matrix associated with the codebook.

30. The apparatus of claim 28, wherein execution of the instructions further cause the apparatus to reconstruct a matrix of the codebook based on a basis pool and the first group of channel coefficients,
wherein the estimate of the channel is recovered based on a product of the matrix and the second group of channel coefficients.
